(19) United States
(12) Patent Application Publication
(10) Pub. No.: US 2009/0063148 A1
(43) Pub. Date: Mar. 5, 2009

(54) CALIBRATION OF WORD SPOTS SYSTEM, METHOD, AND COMPUTER PROGRAM PRODUCT

(76) Inventors: Christopher Nelson Straut, Duluth, GA (US); Joseph Henry Owen, JR., Douglasville, GA (US); Jeffery Robert Giesler, Alpharetta, GA (US); Sara Marie Goss, Atlanta, GA (US)

Correspondence Address: DLA PIPER LLP US, P. O. BOX 2758, RESTON, VA, 20195, US

(21) Appl. No.: 12/040,626

(22) Filed: Feb. 29, 2008

Related U.S. Application Data
(60) Provisional application No. 60/892,538, filed on Mar. 1, 2007.

(51) Int. Cl. G10L 15/04

(52) U.S. Cl. 704/251; 704/E15.001

(57) ABSTRACT

An example embodiment of the invention may include a system, a method and/or a computer program product for enabling calibrating of word spots resulting from a spoken query, including, e.g., but not limited to, presenting a plurality of word spots to a user, each of the plurality of word spots having a confidence level; determining by the user whether at least one of the plurality of word spots is a hit or a false positive by determining whether the at least one of the plurality of word spots matches at least one word In the spoken query; receiving a maximum acceptable percentage of false positives from the user; and determining an acceptable confidence threshold value for the spoken query by locating the smallest confidence level in the plurality of word spots below which the percentage of word spots in the plurality of word spots that are false positives exceeds the maximum acceptable percentage of false positives.

### CROSS-REFERENCE TO RELATED APPLICATIONS

The present application claims benefit of U.S. Provisional Patent Application No. 60/892,538 filed on Mar. 1, 2007 which is related to U.S. patent application Ser. No. 11/498,161 filed Aug. 3, 2006, which claims benefit of Patent Application Ser. No. U.S. 60/709,797 filed Aug. 22, 2005, all of which are of common assignee to the present invention, and the contents of each are incorporated herein by reference in their entirety.

### FIELD OF INVENTION

The present invention relates generally to speech recognition technology, more particularly to word spotting of audio streams and more particularly audio streams using spoken queries.

### BACKGROUND OF THE INVENTION

Speech recognition is a process of converting a speech signal into a sequence of words, by means of an algorithm typically implemented as a computer program. Word spotting is a speech recognition algorithm in which occurrences of a specific word or phrase are detected within an acoustic-based signal. Various tools have been developed for word spotting, an example of which is disclosed in U.S. Patent Application Publication No. 2007/0033003 to Morris, the contents of which are incorporated herein by reference in its entirety.

In a conventional method of word spotting, the target words and phrases are provided by a user, along with a audio file, to a word spotting engine that processes the audio file to locate the target words and phrases in the audio file. An audio session may have zero or more word spots. Each word spot is given a confidence level, which is typically a number between zero to 100, representing the likelihood that the word or phrase spotted by the word spotting engine matches the word or phrase that the user intended. Typically, the higher the confidence level, the more likely it is for the word spot to be accurate (i.e. a hit) rather than a word that was not intended by the user to be spotted (i.e. a false positive). The word spotting engine then outputs putative word spots that have a confidence level above a predefined minimum threshold.

In a conventional voice recognition system, once a threshold value is set, the word spotting engine returns only the word spots that have a higher confidence level than the threshold value. Therefore, if the user later determines that the threshold value that was previously set for a word or phrase query does not produce efficient results (e.g. too many false positives or too many misses), the threshold has to be adjusted for that query. After the threshold value is adjusted, all audio files previously analyzed using the old threshold value must be redeployed to the word spotting engine and reanalyzed for word spots using the newly adjusted threshold. This process, however, is too time consuming and inefficient.

In addition, in order to provide a valid threshold value, it may be necessary to analyze a large number of audio files to determine whether the threshold value provides too many misses or too many false positives. In a conventional voice recognition system, the audio files processed by the word spotting engine need to be stored locally on a workstation running the word spotting engine, since the calibration process requires the audio files to be redeployed to the word spotting engine. This single threaded approach, however, is too time consuming where large numbers of data files are to be analyzed by users.

### SUMMARY OF THE INVENTION

In order to address shortcomings of conventional solutions, it is a feature of the present invention to encompass various example embodiments of a system, method, and computer software product, that may allow calibration of word spotting of audio files in order to determine the best acceptable confidence threshold value.

The invention provides a method of calibrating word spots resulting from a spoken query, including presenting a plurality of word spots to a user, each of the plurality of word spots having a confidence level; determining by the user whether at least one of the plurality of word spots is a hit or a false positive; receiving a maximum acceptable percentage of false positives from the user; and determining an acceptable confidence threshold value for the spoken query by locating the smallest confidence level in the plurality of word spots below which the percentage of word spots in the plurality of word spots that are false positives exceeds the maximum acceptable percentage of false positives.

### BRIEF DESCRIPTION OF THE DRAWINGS

In the accompanying drawings like reference numbers generally indicate identical, functionally similar, and/or structurally similar elements.

FIG. 1 depicts a flow diagram illustrating the process of word spotting in a word spotting engine, according to an embodiment of the present invention;

FIG. 2 depicts a flow diagram illustrating the process of calibration, according to an embodiment of the present invention;

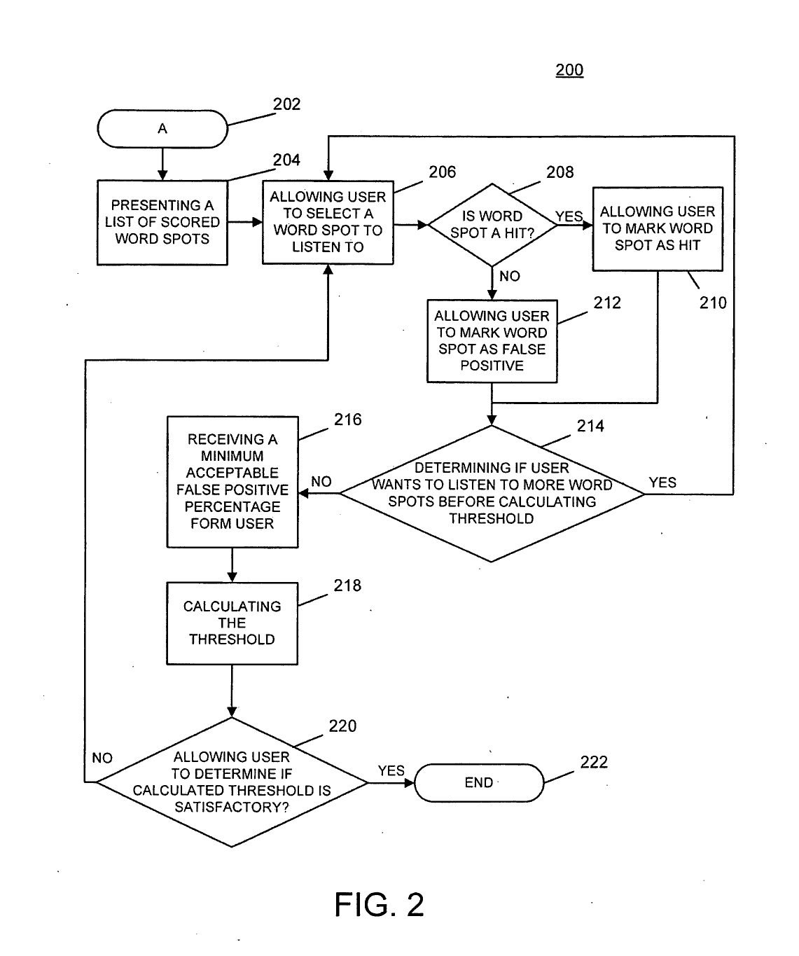

FIG. 3A illustrates an example of a table illustrating various word spots to help explain how the threshold value is determined, according to an embodiment of the present invention;

FIG. 3B shows a table where the various word spots in FIG. 3A are sorted in the order of their confidence level;

FIG. 4 illustrates an example of a graphical user interface for updating a query, according to an embodiment of the present invention;

FIG. 5 illustrates an example of a graphical user interface that includes, but not limited to, a listing of word spots, audio thumbnails for each word spot, a visibility flag for each word spot, and the confidence value of each word spot, according to an embodiment of the present invention; and

FIG. 6 depicts a computer system that may be used in implementing the process of word spotting, according to an embodiment of the present invention.

### DETAILED DESCRIPTION OF EMBODIMENTS OF THE INVENTION

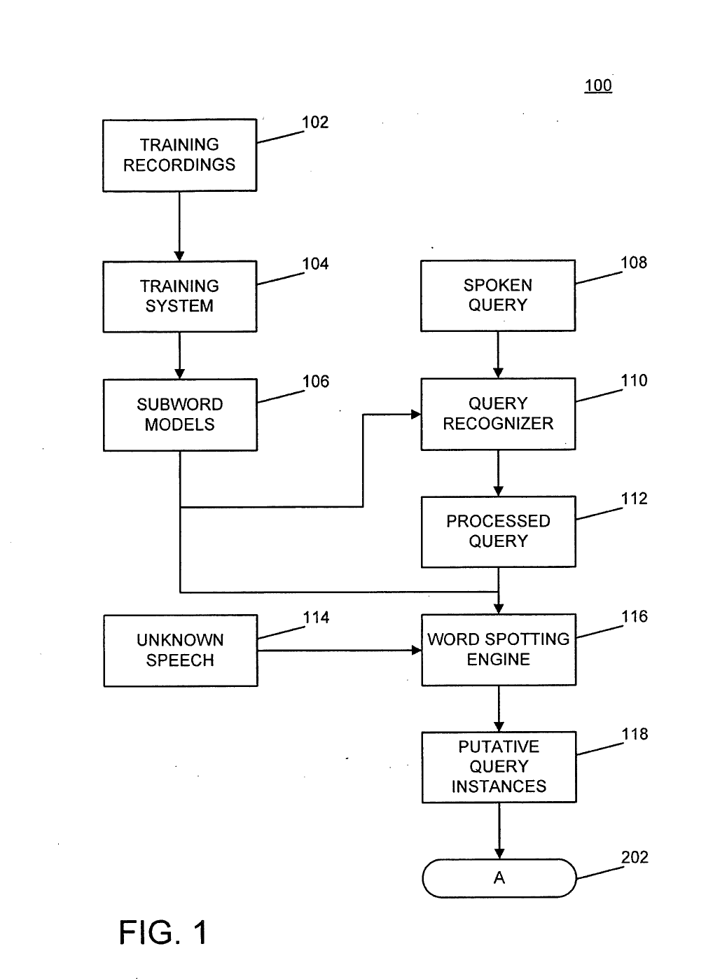

FIG. 1 depicts a flow diagram illustrating a process of word spotting in a word spotting engine, according to an embodiment of the present invention. The word spotting process 100 may include a spoken query 108. In one embodiment, the spoken query 108 may be a word, words and/or phrases that a user may intend to locate in an audio stream, or it may be a combination of words or phrases. For example, a query may be for the word, words and/or phrases “gift,” “giving card,” and “pink ribbon transaction,” whereas another query may be for the words “morning” and “afternoon”. In one embodiment, the spoken query 108 may be passed on to the query recognizer 110, which may process the acoustic data associated with the spoken query using a speech recognition algorithm to produce the processed query 112. In one embodiment, the processed query 112 may include the data representation of the spoken query in terms of sub-word linguistic units. In one embodiment, the processed query 112 may then be passed to the word spotting engine 116. In one embodiment, the word spotting engine 116 may process unknown speech 114, which may be an audio file, to locate specific instances at which the spoken query 108 is likely to have occurred.

In an embodiment of the invention, the word spotting system 100 may utilize a process known as the Hidden Markov Model (HMM), which is a statistical model used to output a sequence of symbols or quantities. In one embodiment using this model, training recordings 102 may be used by the training system 104. The training system may implement a statistical training procedure to determine the transition probabilities of the subword models 106. In one embodiment, the query recognizer 110 and the word spotting engine 116 may both use the subword models 106.

In one embodiment, in addition to spotting the spoken query 108 in the unknown speech 114, the word spotting engine 116 may also associate each instance with a score that may characterize a confidence level for the spoken query 108. The operation of the word spotting engine 116 may be as described in a published article entitled “Scoring Algorithms for Wordspotting Systems,” by Robert W. Morris, Jon A. Arrowood, Peter S. Cardillo and Mark A. Clemens, the contents of which are incorporated herein by reference. The confidence level, which may typically be a number between zero to 100, may represent the likelihood that the spoken query spotted by the word spotting engine 116 has truly occurred. In one embodiment, the word spotting engine 116 may use a probability score approach to compute the confidence level, in which a probability of the query event occurring is computed for each instance. One possible approach is described in the Morris et al. article. In one embodiment, the higher the confidence level, the more likely it is for the word spot to be accurate (i.e. a hit) rather than a word that was not intended by the user to be spotted (i.e. a false positive). In addition, in one embodiment, the word spotting engine 116 may also be provided with a predetermined threshold. Finally, in one embodiment, all putative query instances 1118 that exceed the predetermined threshold may be reported by the word spotting engine 116.

In an embodiment of the invention, the process 100 may proceed to continue with calibration process 200 which can occur in real-time. Real-time in this context means that new word spots can come in during the actual calibration procedure and can be used by the process. Since there may be no delay in the capture of the word spot, it is considered available immediately for use, i.e., in real-time. From 202, the calibration process 200 may proceed to 204, where a list of scored word spots may be provided. The scores represent the confidence level associated with each word spot may be presented. The word spotting engine assigns the confidence of the word spot. One method of assigning a confidence level for each word spot can be found, for example, in the Morris et al. article.

From 204, the process 200 may continue with 206, where a user may select a word spot to which to listen. In one embodiment, the user may be presented with a short audio clip immediately before and after the location of the word spot within the audio file that the user can listen to in order to determine whether the target word or phrase was actually uttered in the audio clip.

From 206, the process 200 may proceed with 208, where the user may determine if the word spot was a hit (i.e. word spot was a good match) or if the word spot was a false positive (i.e. the word spot does not actually match the target word or phrase). If the word spot is a hit, the user may mark the word spot as a hit in 210. If the word spot is instead a false positive, the user may mark the word spot as a false positive in 212. In one embodiment, the user may perform this process through a user interface that may present the user with a list of word spot results to listen to, along with user interface objects such as, e.g., but not limited to, checkboxes, radio buttons, and/or bullets for flagging and/or marking each word spot as a hit or a false positive. The user interface can be, for example, an application which may be browser-based. For example, the interface can be an applet or an application. The application can be a multi-user application.

In one embodiment, the more word spots a user reviews for a given query, the more precisely the threshold value for that query may be calculated. Accordingly, in one embodiment, when the word spot confidence is above this threshold value, it may be assumed that the word spot may typically be a hit, and when the word spot confidence is below this threshold value, it may be assumed that the word spot may typically be a false positive. In one embodiment, this threshold value may be used later to analyze the word spot data.

In one embodiment, as each word spot is reviewed, the application may keep track of and update the status of a word spot (i.e. whether the word spot is a hit or a false positive). In one embodiment, the user may also be provided with an option to flag the word spot as invisible, so that the word spot may be invisible to end users of the application viewing the word spots corresponding to a query. For example, as the word spot is determined by the user to be a hit or a false-positive, the status of the word spot can be updated to be viewable by the end user of the system if it is a hit or not viewable if it is a false positive.

From 210 or 212, the user may proceed to listen to more word spots or to calculate the threshold value for the spoken query. In one embodiment, the user may make this determination in 214. If the user wishes to listen to more word spots, the process 200 may continue back with 206. Otherwise, the user may then be provided with an option to enter an acceptable percentage of false positives value in 216.

The acceptable percentage of false positives value may be provided to a systems engineer by the end user of the product, e.g., but not limited to, a client. In one embodiment, it may be acceptable to an end user to have a maximum of, for example, 10%, 15%, 20%, etc. word spots that may be false positives within the pool of word spots. Typically, the higher is the acceptable percentage of false positives, the more likely it is that a word spot returned to the end user is a false positive, while at the same time, the less likely it is that a word or phrase that actually matches the query may be missed.

After 216, the process 200 may continue with 218, in which the threshold value for the real-time calibration engine may be recalculated. The threshold value may be calculated based on the acceptable percentage of false positives value, as may be provided by the end user, and the number of hits and false positives. In one embodiment, the word spots flagged as hits or false positives, along with their confidence values determined by the spotting engine, may be reviewed and a threshold that would balance the needs of the user to maximize the hits while minimizing false positives may be suggested. In one embodiment, this value may be known as an acceptable confidence threshold. In one embodiment, the acceptable confidence threshold may be determined by arranging all the word spots in order from highest confidence to lowest confidence and by traversing the list until the percentage of false positives is higher than the acceptable percentage of false positives. In one embodiment, this threshold value may be set to the confidence value below which the percentage of false positives exceeds the acceptable percentage of false positives.

After 218, the process 200 may continue with 220, in which a determination may be made as to whether the calculated threshold is satisfactory. In one embodiment, the calculated threshold may be satisfactory where the threshold value has stabilized, e.g. the threshold value has already been calculated based on a large number of word spots, so the new addition of word spots does not change the value of the threshold. If the threshold value is satisfactory, the process 200 may end at 222. Otherwise, the process 200 may continue to 206, where the user may select other word spots to listen to. In another embodiment, the user may run new unknown speech 114 through the word spotting engine 116 for the same spoken query 108 to retrieve a new set of putative query instances 1118, which can then be used again in process 200 to recalculate the threshold.

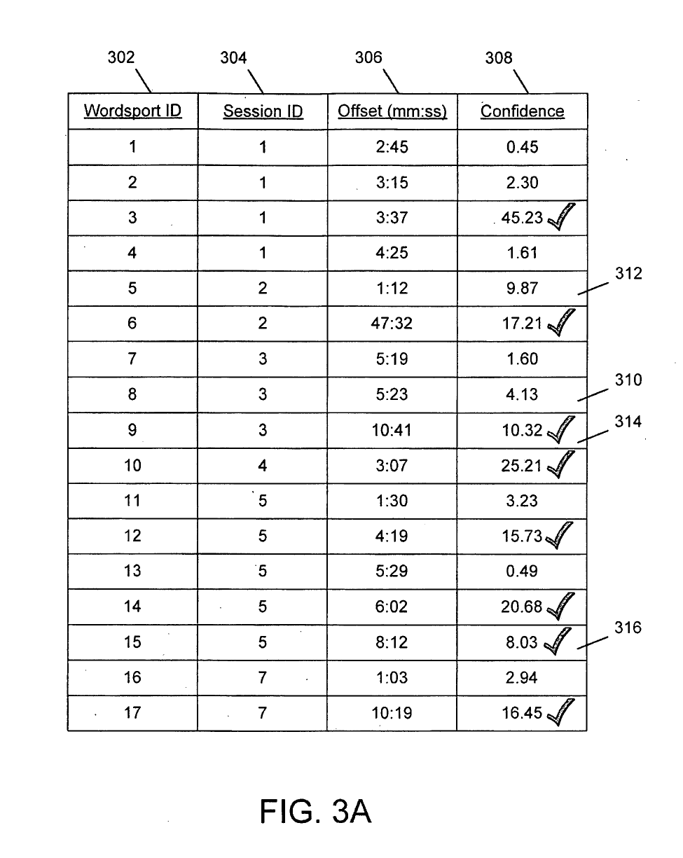

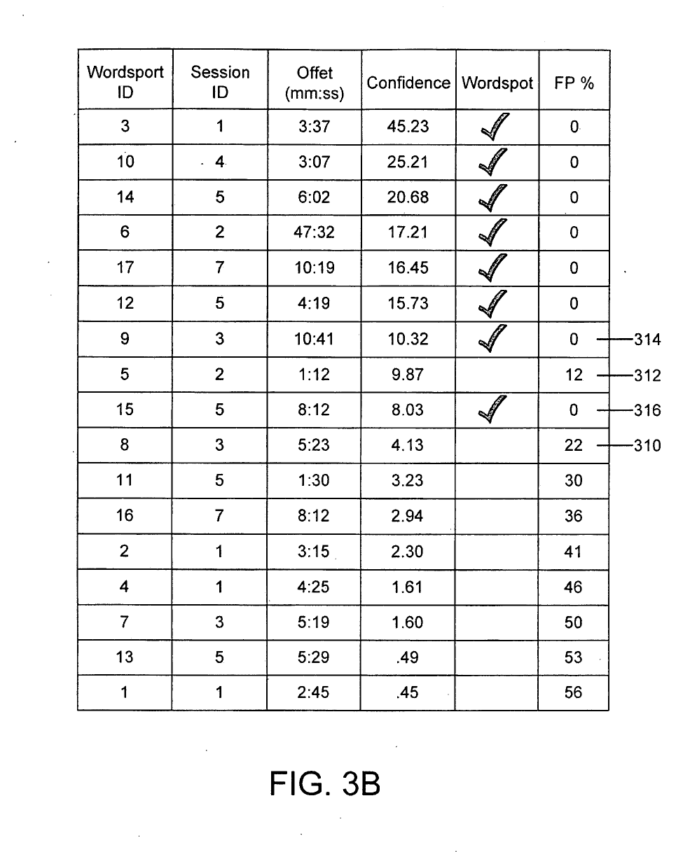

FIG. 3A illustrates an example showing how the acceptable confidence threshold value may be calculated, according to an embodiment of the present invention. In this example, it may be assumed that an end user has been using recording devices (such as, e.g., but not limited to, a digital audio device, an MP3 recording device, etc.) to capture sessions and that these sessions have been run through the word spotting engine. Also, in this example, it may be assumed that the word spotting engine may have been asked to recognize the search query phrase “Our appointment is for” in an example of seven (7) different audio sessions. In the example, the word spot ID 302 may indicate the ID for each word spot detected by the word spot engine, the session ID 304 may indicate the ID of each recorded audio session, the offset 306 may indicate the exact time within that audio session when the word spot may have occurred, and confidence 308 may indicate the confidence level for that word spot occurrence.

As this example illustrates, the threshold value of the word spot engine may be set at such a low value that even word spots having very low confidence values may be returned to the calibration processor. The user may then listen to each word spot audio thumbnail. The audio thumbnail may be a recording which may include a recording including a brief portion immediately before and after the word spot in the audio session. In the example of FIG. 3A, through the review of the word spots, it may have been found that all word spots having a confidence of 4.13 or below are false positives. In addition, it may have been found that the word spot 312 having a confidence of 9.87, is also a false positive. Whereas, it may have been found that all word spots having a confidence of 10.32 or above, as well as the word spot 316 having a confidence of 8.03, are hits. In this example, the hits may then be provided with a check mark or other indication of a correct word spot.

In this example, if the end-user wishes no more than 10% of the matches to be false positives, then, the real-time calibration process may sort the word spots in the order of their confidence level (for example in descending order), as shown in FIG. 3B. The calibration process may determine a word spot confidence below which the false positive percentage will be more than 10%. In this example, the suggested threshold may be 10.32, since at next lowest hit word spot 316 having a confidence of 8.03, the word spot 312 having a confidence 9.87 (which is a false positive) will be included, thus resulting in 7 hits and 1 false positive. That one false positive word spot 312 may represent 12% of the overall data set and may trigger the condition to return the previous lowest confidence that was a hit. However, if the user sets the acceptable percentage of false positives to 15%, then a threshold of 8.03 may be suggested, since the percentage of false positives will now allow the inclusion of the false positive word spot 312 having a confidence of 9.87. In one embodiment, it may be best to have a high number of hits before the false positives to achieve good results.

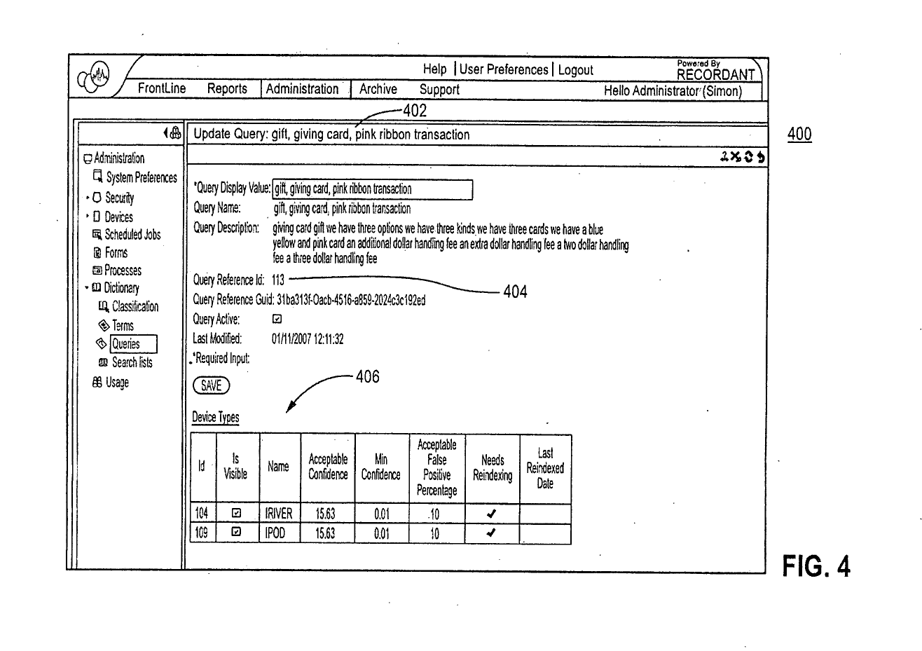

FIG. 4 illustrates an example of a graphical user interface for updating a query, according to an embodiment of the present invention. The graphical user interface (GUI) 400 includes a screen that may provide users with information about a certain query. In one embodiment, a user must log into a website with proper access ID and password in order to access the queries. In one embodiment, after user authentication, the user may be given access to queries designated for that user. Accordingly, in one embodiment, multiple users may have access to the word spots for a query at the same time, allowing them to perform real-time calibration of the word spots simultaneously.

In one embodiment, each query may be associated with one or more query attributes. In one embodiment, GUI 400 illustrated in FIG. 4, may include a query 402 for “gift, giving card, pink ribbon transaction” having query ID 404 and attribute 406. In this example, the listed attribute 406 can be, for example, the device type that was used to capture the recording (e.g., an iPod or iRiver). Other attributes can include, for example, but not limited to, the recording sample rate, the location of the recording (e.g., but not limited to, a service desk v. a private office), the locale of the recording (e.g., but not limited to, Mississippi v. Australia), etc. In one embodiment, each recording in the table may be calibrated independently of the other.

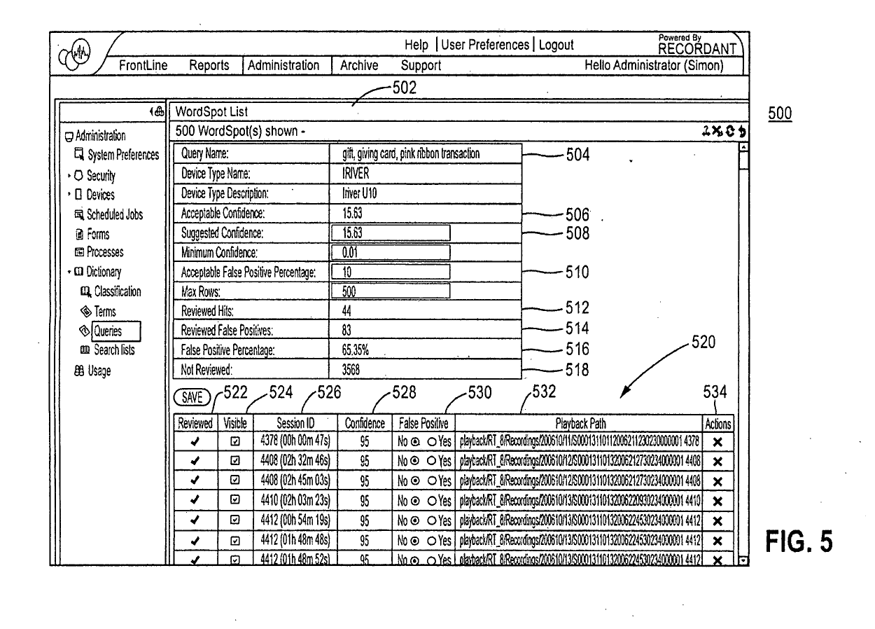

FIG. 5 illustrates an example of a graphical user interface that includes, but not limited to, a listing of word spots, audio thumbnails for each word spot, a visibility flag for each word spot, and the confidence value of each word spot, according to an embodiment of the present invention. Graphical user interface (GUI) 500 includes a screen that may provide users with a word spots list screen 502 for a given query 504. In one embodiment, the acceptable confidence 506 of 15.63 may represent the current confidence threshold level, the suggested confidence 508 may represent the confidence threshold value suggested by the system, and the acceptable false positive percentage 510 may represent the maximum false positive percentage acceptable by the end-user. The list of word spots 520 may include all the word spots associated with the query. In one embodiment, within the list 520, each word spot may include a reviewed flag 522, which may indicate whether the word spot has already been reviewed, a visibility flag 524, which may allow the user to indicate whether the word spot is visible to the end user, a session ID 526, which may indicate the audio session in which the word spot was located, a confidence 528, which may indicate the confidence associated with that word spot, a false positive indicator 530, which may allow the user to flag whether the word spot is a false positive or a hit, a playback path 532, which may allow the user to play the audio clip that may include the word spot, and an actions button 534, which may allow the user performing the calibration to delete the word spot in order to improve the results of the calibration by refining the data set.

In one embodiment, a user or users performing the calibration process may start reviewing each session by clicking a link in the Session ID column 526 of table 520. In one embodiment, the audio thumbnail may start playing back, including the utterance of the word spot. The user may then mark the word spot as having been reviewed in column 522. The system may also update the “Not Reviewed” field 518.

In one embodiment, after listening to the audio thumbnail, the user may then determine if the actual target words or phrases were stated and mark each of the word spots as a “false positive” or “hit,” accordingly. The system may also update the “Reviewed Hit” field 512 and “Reviewed False Positives” field 514 and may recalculate the “False Positive Percentage” field 516, accordingly.

In one embodiment, the user may then continue to the next word spot and may repeat the process. In one embodiment, after enough word spots have been listened to, the user may then click the “Suggest Threshold” button (see question mark (?) icon on upper right), which may trigger the system to go through the list of word spots and may determine the appropriate threshold that might be acceptable to the end user.

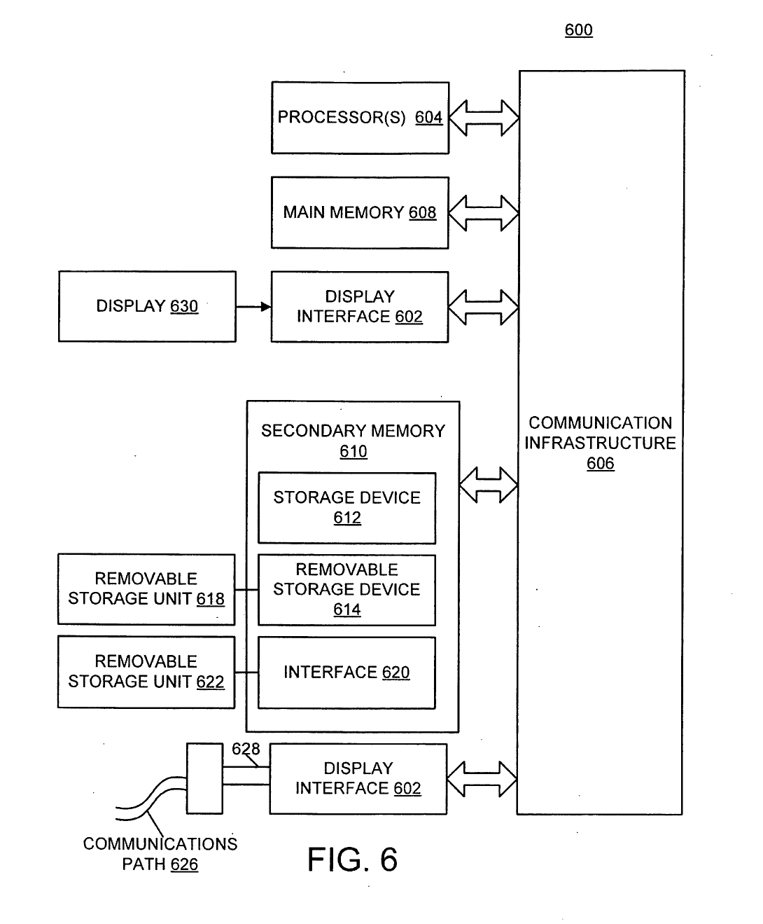

FIG. 6 depicts an example computer system that may be used in implementing the process of word spotting, according to an embodiment of the present invention. Specifically, FIG. 6 depicts an example embodiment of a computer system 600 that may be used in computing devices such as, e.g., but not limited to, a client and/or a server, etc., according to an embodiment of the present invention. FIG. 6 depicts an example embodiment of a computer system that may be used as client device 600, or a server device 600, etc. The present invention (or any part(s) or function(s) thereof) may be implemented using hardware, software, firmware, or a combination thereof and may be implemented in one or more computer systems or other processing systems. In fact, in one embodiment, the invention may be directed toward one or more computer systems capable of carrying out the functionality described herein. FIG. 6 depicts a block diagram of computer system 600 useful for implementing the present invention. The computer system 600 can be, for example, but not limited to, a personal computer (PC) system running an operating system such as, for example, but not limited to, MICROSOFT® WINDOWS® NT/98/2000/XP/CE/ME/etc. available from MICROSOFT® Corporation of Redmond, Wash., U.S.A. However, the implementation of the invention may not be limited to these platforms. Instead, the invention may be implemented on any appropriate computer system running any appropriate operating system. In one embodiment, the present invention may be implemented on a computer system operating as discussed herein. An example computer system, computer 600 may be shown in FIG. 6. Other components of the invention, such as, e.g., but not limited to, a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 6. Services may be provided on demand using, e.g., but not limited to, an interactive television (iTV), a video on demand system (VOD), and via a digital video recorder (DVR), or other on demand viewing system.

The computer system 600 may include one or more processors, such as, e.g., but not limited to, processor(s) 604. The processor(s) 604 may be connected to a communication infrastructure 606 (e.g., but not limited to, a communications bus, crossover bar, or network, etc.). Various software embodiments may be described in terms of this example computer system. After reading this description, it may become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 630.

The computer system 600 may also include, e.g., but may not be limited to, a main memory 608, random access memory (RAM), and a secondary memory 610, etc. The secondary memory 610 may include, for example, but not limited to, a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, optical disk, compact disk, etc. which may be read from and written to by removable storage drive 614. As may be appreciated, the removable storage unit 618 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device 616 such as, e.g., but not limited to, a mouse or other pointing device such as a digitizer, and a keyboard or other data entry device (not shown).

Computer 600 may also include output devices, such as, e.g., but not limited to, display 630, and display interface 602. Computer 600 may include input/output (I/O) devices such as, e.g., but not limited to, communications interface 624, cable 628 and communications path 626, etc. These devices may include, e.g., but not limited to, a network interface card, and modems (neither are labeled). Communications interface 624 may allow software and data to be transferred between computer system 600 and external devices.

In this document, the terms “computer program medium” and “computer readable medium” may be used to generally refer to media such as, e.g., but not limited to removable storage drive 614, a hard disk installed in hard disk drive 612, and cable(s) 628, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an example embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate, interact or communicate with each other.

An algorithm may be here, and generally, considered to be a self consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another example embodiment, the invention may be implemented using a combination of any of, e.g., but not limited to, hardware, firmware and software, etc.

While various embodiments of the present invention have been described above, it should be understood that they have been presented by way of example only, and not limitation. Thus, the breadth and scope of the present invention should not be limited by any of the above-described example embodiments, but should instead be defined only in accordance with the following claims and their equivalents.

What is claimed is:

1. A method of calibrating word spots resulting from a spoken query, comprising:
presenting a plurality of word spots to a user, each of the plurality of word spots being associated with a confidence level;
determining by the user whether at least one of the plurality of word spots is a hit or a false positive by determining whether the at least one of the plurality of word spots matches at least one word in the spoken query;
receiving a maximum acceptable percentage of false positives from the user; and
determining an acceptable confidence threshold value for the spoken query by locating the smallest confidence level in the plurality of word spots below which a percentage of word spots in the plurality of word spots that are false positives exceeds the maximum acceptable percentage of false positives.

2. The method of claim 1, wherein the presenting of the plurality of word spots includes presenting the plurality of word spots to a plurality of users.

3. The method of claim 1, wherein the determining by the user whether the at least one of the plurality of word spots is a hit or a false positive includes selecting by the user the at least one of the plurality of word spots and listening by the user of an audio recording including the at least one of the plurality of word spots.

4. The method of claim 3, wherein the listening includes listening to the audio recording before and after the at least one of the plurality of word spots.

5. The method of claim 3, wherein the determining by the user whether the at least one of the plurality of word spots is a hit or a false positive includes marking the at least one of the plurality of word spots when the at least one of the plurality of word spots is a hit.

6. The method of claim 1, wherein the determining of the acceptable confidence threshold value for the spoken query includes sorting the plurality of word spots in the order of their respective associated confidence level.

7. The method of claim 1, further comprising determining by the user whether the confidence threshold value is satisfactory by checking whether the confidence threshold value has stabilized.

8. The method of claim 7, wherein the checking includes checking whether adding of a word spot to the plurality of word spots does not substantially change the confidence threshold value.

9. The method of claim 7, further comprising selecting another word spot in the plurality of the word spots and determining by the user whether this other word spot in the plurality of word spots is a hit or a false positive.

10. The method of claim 1, further comprising:
receiving the plurality of word spots from a word spotting engine, wherein an engine threshold value for the word spotting engine is set at a lower value than the acceptable confidence threshold value.

11. The method of claim 1, further comprising storing the plurality of word spots in a computer readable medium.

12. The method of claim 1, further comprising:
receiving a query request for an unknown speech sample from the user; and
displaying the plurality of word spots having a confidence level below the acceptable confidence threshold value to the user.

13. The method of claim 1, further comprising performing the calibration in real-time.

14. A system for calibrating word spots resulting from a spoken query, comprising:
a word spotting engine comprising an input adapted to receive at least one spoken query, an input adapted to receive audio data, and an output configured to output a plurality of word spots associated with the spoken query, each of the plurality of word spots being associated with a confidence level, the word spotting engine being configured to receive an engine threshold value; and
a calibration engine configured to determine an acceptable confidence threshold value using the confidence value of each of the plurality of word spots,
wherein said engine threshold value is lower than the confidence threshold value.

15. The system of claim 14, further comprising a storage unit for storing the plurality of word spots.

16. The system of claim 14, wherein the calibration engine comprises an input for indicating whether at least one of the plurality of word spots is a hit when the at least one of plurality of word spots matches at least one word in the spoken query or a false positive when the at least one of the plurality of word spots does not match at least one word in the spoken query.

17. The system of claim 14, wherein the calibration engine comprises an input for receiving a maximum acceptable percentage of false positives.

18. The system of claim 14, wherein the calibration engine comprises
a calibration engine configured to determine an acceptable confidence threshold by locating the smallest confidence level in the plurality of word spots below which a percentage of word spots in the plurality of word spots that are false positives exceeds the maximum acceptable percentage of false positives.

19. The system of claim 14, wherein the output is accessible to a plurality of users.

20. The system of claim 14, further comprising an output configured to output an audio recording including at least one of the plurality of word spots.

21. The system of claim 20, wherein the audio recording includes an audio recording before and after the at least one of the plurality of word spots.

22. The system of claim 14, further comprising an input for marking the at least one of the plurality of word spots when the at least one of the plurality of word spots is a hit.

23. The system of claim 14, wherein the calibration engine is configured to sort the plurality of word spots in the order of their respective associated confidence level.

24. The system of claim 14, wherein the calibration engine is a real-time calibration.
